(19) United States
(12) Patent Application Publication
(10) Pub. No.: US 2025/0206965 A1
(43) Pub. Date: Jun. 26, 2025

(54) MULTILAYER COATING FILM AND COATED ARTICLE, AND METHOD FOR PRODUCING COATED ARTICLE

(71) Applicant: NIPPON PAINT AUTOMOTIVE COATINGS CO., LTD., Hirakata-shi, Osaka (JP)

(72) Inventors: Ryoichi YONEYAMA, Hirakata-shi, Osaka (JP); Ryohei TSUBONE, Hirakata-shi, Osaka (JP); Shinichi FUJIWARA, Hirakata-shi, Osaka (JP)

(21) Appl. No.: 18/970,302

(22) Filed: Dec. 5, 2024

(30) Foreign Application Priority Data
Dec. 26, 2023 (JP) 2023-219054

(51) Int. Cl. C09D 5/36; C09D 7/40; C09D 7/62

(52) U.S. Cl. CPC C09D 5/36; C09D 7/62; C09D 7/70

(57) ABSTRACT

The multilayer coating film includes a first coating film, a second coating film, and a clear coating film, in which the second coating film contains a scaly pigment coated with a metal oxide, the chroma C1*₄₅ and the lightness L1*₄₅ of the first coating film satisfy the relationships of C1*₄₅≤15 and 20≤L1*₄₅≤70, the lightness L1*₁₅ and the lightness L1*₁₁₀ satisfy the relationship of L1*₁₅-L1*₁₁₀≤15, the second coating film has an average light transmittance of 50% or more, and the chroma Cm*₁₅ and Cm*₄₅ of the multilayer coating film satisfy the relationships of Cm*₁₅>10 and Cm*₁₅-Cm*₄₅>5.

### CROSS REFERENCE TO RELATED APPLICATIONS

This application claims priority based on Japanese Patent Application No. 2023-219054, which was filed in Japan on Dec. 26, 2023, the entire contents of which is incorporated herein by reference.

### TECHNICAL FIELD

The present invention relates to a multilayer coating film, a coated article, and a method for producing a coated article.

### BACKGROUND ART

An exterior of an automobile is usually provided with a multilayer coating film. Patent Document 1 discloses a laminated coating film having a white coating film appearance.

### Patent Document

Patent Document 1: JP 5213049 B2

### SUMMARY OF THE DISCLOSURE

In recent years, designs required for multilayer coating films are diversified due to diversification of consumers' preferences and pursuit of originality. An object of the present invention is to provide a multilayer coating film having a design different from that of Patent Document 1 in which a calm gray color is exhibited in a face region and a chromatic tint is sensed in a highlight region.

In order to solve the above-described problems, the present invention provides the following embodiments.

[1]

A multilayer coating film including a first coating film, a second coating film disposed on the first coating film, and a clear coating film disposed on the second coating film,
in which
the second coating film contains a scaly pigment coated with a metal oxide,
a chroma C1*₄₅ and a lightness L1*₄₅ in an L*C*h color system based on a spectral reflectance of reflected light R1₄₅ having received, at an angle of 45 degrees with respect to specular light, incident light I1₄₅ striking at an angle of 45 degrees with respect to a surface of the first coating film satisfy relationships of:

$$C {1}_{45}^{*} \leq 15$$

$$20 \leq L {1}_{45}^{*} \leq 70 ,$$

a lightness L1*₁₅ in the L*C*h color system based on a spectral reflectance of reflected light R1₁₅ having received the incident light I1₄₅ at an angle of 15 degrees with respect to the specular light, and a lightness L1*₁₁₀ in the L*C*h color system based on a spectral reflectance of reflected light R1₁₁₀ having received the incident light I1₄₅ at an angle of 110 degrees with respect to the specular light satisfy a relationship of:

$$L {1}_{15}^{*} - L {1}_{110}^{*} \leq 15 ,$$

the second coating film has an average light transmittance at a wavelength of 400 nm to 700 nm of 50% or more, and
a chroma Cm*₁₅ in the L*C*h color system based on a spectral reflectance of reflected light Rm₁₅ having received, at an angle of 15 degrees with respect to specular light, incident light Im₄₅ striking at an angle of 45 degrees with respect to a surface of the multilayer coating film, and a chroma Cm*₄₅ in the L*C*h color system based on a spectral reflectance of reflected light Rm₄₅ having received the incident light Im₄₅ at an angle of 45 degrees with respect to the specular light satisfy relationships of:

$$C {m}_{15}^{*} > 10$$

$$C {m}_{15}^{*} - C {m}_{45}^{*} > 5 .$$

[2]

The multilayer coating film according to [1], in which a chroma C2*₁₅ in the L*C*h color system based on a spectral reflectance of reflected light R2₁₅ having received, at an angle of 15 degrees with respect to specular light, incident light I2₄₅ striking at an angle of 45 degrees with respect to a surface of a test coating film obtained by applying, onto a black article to be coated, a second coating composition to be used for formation of the second coating film satisfies a relationship of:

$$C {2}_{15}^{*} \geq 5 .$$

[3]

The multilayer coating film according to [1] or [2], in which a content of the scaly pigment is 0.5% to 20% by mass of the second coating film.

[4]

The multilayer coating film according to [1] or [2], in which
the second coating film further contains a coloring pigment, and
a content of the coloring pigment is 0.05% to 1.5% by mass of the second coating film.
   [5]

The multilayer coating film according to [4], in which a mass ratio of the scaly pigment to the coloring pigment is 2 to 400 or less.

[6]

A coated article including:
an article to be coated; and
the multilayer coating film according to [1] disposed on the article to be coated.
   [7]

A method for producing a coated article having a multilayer coating film including a first coating film, a second coating film disposed on the first coating film, and a clear coating film disposed on the second coating film, the method including:
applying a first coating composition onto an article to be coated to form the first coating film;
applying a second coating composition containing a scaly pigment coated with a metal oxide onto the first coating film to form the second coating film; and
applying a clear coating composition onto the second coating film to form the clear coating film,
in which
a chroma C1*₄₅ and a lightness L1*₄₅ in an L*C*h color system based on a spectral reflectance of reflected light R1₄₅ having received, at an angle of 45 degrees with respect to specular light, incident light I1₄₅ striking at an angle of 45 degrees with respect to a surface of the first coating film satisfy relationships of:

$$C {1}_{45}^{*} \leq 15$$

$$20 \leq L {1}_{45}^{*} \leq 70 ,$$

a lightness L1*₁₅ in the L*C*h color system based on a spectral reflectance of reflected light R1₁₅ having received the incident light I1₄₅ at an angle of 15 degrees with respect to the specular light, and a lightness L*₁₁₀ in the L*C*h color system based on a spectral reflectance of reflected light R1₁₁₀ having received the incident light I1₄₅ at an angle of 110 degrees with respect to the specular light satisfy a relationship of:

$$L {1}_{15}^{*} - L {1}_{110}^{*} \leq 15 ,$$

the second coating film has an average light transmittance at a wavelength of 400 nm to 700 nm of 50% or more, and
a chroma Cm*₁₅ in the L*C*h color system based on a spectral reflectance of reflected light Rm₁₅ having received, at an angle of 15 degrees with respect to specular light, incident light Im₄₅ striking at an angle of 45 degrees with respect to a surface of the multilayer coating film, and a chroma Cm*₄₅ in the L*C*h color system based on a spectral reflectance of reflected light Rm₄₅ having received the incident light Im₄₅ at an angle of 45 degrees with respect to the specular light satisfy relationships of:

$$C {m}_{15}^{*} > 10$$

$$C {m}_{15}^{*} - C {m}_{45}^{*} > 5 .$$

According to the present invention, there are provided a multilayer coating film with which a calm gray color is exhibited in a face region and a chromatic tint is sensed in a highlight region, a coated article having the multilayer coating film, and a method for producing the same.

### BRIEF DESCRIPTION OF DRAWING

FIG. 1 is a diagram for explaining a light-receiving angle.

### DETAILED DESCRIPTION OF THE PREFERRED EMBODIMENTS

### [Multilayer Coating Film]

The multilayer coating film of the present disclosure includes a first coating film, a second coating film disposed on the first coating film, and a clear coating film disposed on the second coating film. The second coating film contains a scaly pigment coated with a metal oxide.

A chroma C1*₄₅ and a lightness L1*₄₅ in an L*C*h color system based on a spectral reflectance of reflected light R1₄₅ having received, at an angle of 45 degrees with respect to specular light, incident light I1₄₅ striking at an angle of 45 degrees with respect to a surface of the first coating film satisfy relationships of:

$$C {1}_{45}^{*} \leq 15$$

$$20 \leq L {1}_{45}^{*} \leq 70 .$$

This indicates that the first coating film has a solid tone and is in a gray color gamut.

In the first coating film, a lightness L1*₁₅ in the L*C*h color system based on a spectral reflectance of reflected light R1₁₅ having received the incident light I1₄₅ at an angle of 15 degrees with respect to the specular light, and a lightness L1*₁₁₀ in the L*C*h color system based on a spectral reflectance of reflected light R1₁₁₀ having received the incident light I1₄₅ at an angle of 110 degrees with respect to the specular light satisfy a relationship of:

$$L {1}_{15}^{*} - L {1}_{110}^{*} \leq 15.$$

This indicates that the first coating film has a low flip-flop property, more specifically, the first coating film is not a coating film that exhibits a high flip-flop property like a metallic coating film.

The second coating film has an average light transmittance at a wavelength of 400 nm to 700 nm of 50% or more. That is, the second coating film has high light transmissivity in the visible light region. As a result, the tint (gray color) of the first coating film is sensed through the second coating film. In other words, the tint of the first coating film shown through the second coating film is felt as a design of the multilayer coating film.

The second coating film contains a scaly pigment coated with a metal oxide. Since such a scaly pigment has optical coherence, the color appears to change depending on the observation direction.

A chroma Cm*₁₅ in the L*C*h color system based on a spectral reflectance of reflected light Rm₁₅ having received, at an angle of 15 degrees with respect to specular light, incident light Im₄₅ striking at an angle of 45 degrees with respect to a surface of the multilayer coating film (a surface on the clear coating film side), and a chroma Cm*₄₅ in the L*C*h color system based on a spectral reflectance of reflected light Rm₄₅ having received the incident light Im₄₅ at an angle of 45 degrees with respect to the specular light satisfy relationships of.

$$C {m}_{15}^{*} > 10$$

$$C {m}_{15}^{*} - C {m}_{45}^{*} > 5 .$$

This indicates that the multilayer coating film has a chromatic tint in the highlight region, and the tint changes between the highlight region and the face region.

In the present disclosure, a first coating film having a low chroma, a specific lightness, and a low flip-flop property, having a solid tone, and being in a gray color gamut is combined with a second coating film containing a light coherent scaly pigment (hereinafter sometimes referred to as “light interference pigment”) and having light transmissivity. By blending the light interference pigment in a coating film different from one in which the first coating film is blended, it is possible to express a new design in which a calm solid gray color (achromatic color) is exhibited in the face region and a chromatic tint is sensed in the highlight region.

A highlight region refers to a range of −25 to 25 degrees with respect to the specular light of light striking at an angle of 45 degrees. A shade region refers to a range of 75 degrees or more with respect to the specular light of light striking at an angle of 45 degrees. The face region is a range between a highlight region and a shade region (greater than 25 degrees and less than 75 degrees with respect to the specular light). In the present disclosure, as the highlight region, a chroma at an angle of 15 degrees with respect to the specular light, which can be called a super highlight region, is prescribed.

The chroma C*₄₅ is a chroma in an L*C*h color system based on the spectral reflectance of reflected light having received, at an angle of 45 degrees with respect to specular light, incident light I₄₅ striking at an angle of 45 degrees with respect to a surface of a coating film of interest. The Chroma C*₁₅ is defined in the same manner as above except that the incident light I₄₅ is received at an angle of 15 degrees with respect to the specular light. In the L*C*h color system, the vividness of a coated film of interest increases as the numerical value of the chroma C* increases, whereas the dullness increases as the numerical value of the chroma C* decreases.

The lightness L*₄₅ is a lightness in an L*C*h color system based on the spectral reflectance of reflected light having received, at an angle of 45 degrees with respect to specular light, incident light I₄₅ striking at an angle of 45 degrees with respect to a surface of a coating film of interest. The lightness L*₁₅ and the lightness L*₁₁₀ are defined in the same manner as above except that the incident light I₄₅ is received at an angle of 15 degrees and 110 degrees, respectively, with respect to the specular light. In the L*C*h color system, the brightness of a coated film of interest increases as the numerical value of the lightness L* increases, whereas the darkness increases as the numerical value of the lightness L* decreases.

The L*C*h color system is calculated on the basis of the CIE L*a*b color system (CIE 1976 L*a*b* color space). The CIE 1976 L*a*b* color space can be determined in accordance with JIS Z 8781-4. The CIE L*a*b color system is a color system defined by the International Commission on Illumination and described in Section 4.2 of CIE Publication 15.2 (1986).

The chroma C* and the lightness L* can be acquired using a spectrophotometer (for example, BYK-mac i manufactured by BYK Gardner GmbH).

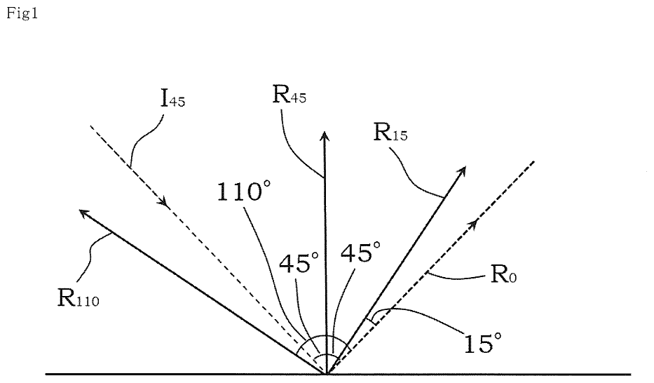

FIG. 1 is a diagram for explaining a light-receiving angle. The specular light of the incident light I₄₅ striking at an angle of 45 degrees with respect to a surface of a coating film is indicated by R₀. The reflected light received at an angle of 15 degrees toward the incident light I₄₅ with respect to the specular light of the incident light is indicated by R₁₅. The lightness L*₁₅ and the chroma C*₁₅ are calculated from the spectral reflectance of the reflected light R₁₅. The reflected light received at an angle of 45 degrees toward the incident light I₄₅ with respect to the specular light of the incident light is indicated by R₄₅. The lightness L*₄₅ and the chroma C*₄₅ are calculated from the spectral reflectance of the reflected light R₄₅. The reflected light received at an angle of 110 degrees toward the incident light I₄₅ with respect to the specular light of the incident light is indicated by R₁₁₀. The lightness L*₁₁₀ is calculated from the spectral reflectance of the reflected light R₁₁₀.

### (First Coating Film)

The first coating film is in a gray color gamut and gives a gray tint to the multilayer coating film. The first coating film is typically a cured product of a first coating composition containing a pigment that adjusts lightness (typically, white and black pigments) and a coating film-forming resin.

The chroma C1*₄₅ and the lightness L1*₄₅ of the first coating film satisfy the relationship of:

$$C {1}_{45}^{*} \leq 15$$

$$20 \leq L {1}_{45}^{*} \leq 70 .$$

When the first coating film is in the gray color gamut, the characteristics of the light interference pigment contained in the second coating film are exerted, and the multilayer coating film generates a desired tint in the highlight region.

C1*₄₅ may be 12 or less, and may be 10 or less. C1*₄₅ may be 1.0 or more, and may be 1.5 or more.

L1*₄₅ may be 30 or more, and may be 40 or more. L1*₄₅ may be 67 or less, and may be 65 or less.

The spectral reflectance of the reflected light R1 is measured not for a multilayer coating film but for a single first coating film. The single first coating film refers to a cured coating film of the first coating composition applied to an article to be coated. The single first coating film is obtained by spray-applying the first coating composition to be used for the formation of a first coating film onto an article to be coated so as to have a dry coating film thickness of 3 to 20 μm (typically 15 μm), and heating and curing the applied first coating composition at 140° C. for 20 minutes, the article to be coated having been prepared by applying a cationic electrodeposition coating material and an intermediate coating material to a steel sheet and then heating and curing these coating materials.

The lightness L1*₁₅ and the lightness L1*₁₁₀ of the first coating film satisfy the relationship of:

$$L {1}_{15}^{*} - L {1}_{110}^{*} \leq 15.$$

L1*₁₅-L1*₁₁₀ may be 12 or less, may be 10 or less, and may be 8 or less. L1*₁₅-L1*₁₁₀ may be 0, and may be 0.5 or more.

L1*₁₅ is, for example, 20 or more and 80 or less. L1*₁₅ may be 30 or more, and may be 40 or more. L1*₁₅ may be 77 or less, and may be 75 or less.

L1*₁₁₀ is, for example, 10 or more and 70 or less. L1*₁₁₀ may be 20 or more, and may be 30 or more. L1*₁₁₀ may be 67 or less, and may be 65 or less.

The spectral reflectance of the reflected light R1 of the first coating film can be adjusted by, for example, the type and mass of the pigments contained in the first coating film and the thickness of the first coating film.

The thickness of the first coating film may be, for example, 3 to 20 μm. The thickness of the first coating film may be 7 μm or more. The thickness of the first coating film may be 15 μm or less, may be 14 μm or less, and may be 13 μm or less.

### (Second Coating Film)

The second coating film contains a light interference pigment. A chromatic tint that changes depending on the observation direction is developed by the light interference pigment. Therefore, the tint of the multilayer coating film becomes more vivid from the face region toward the highlight region. The second coating film is typically a cured product of a second coating composition containing a light interference pigment and a coating film-forming resin.

The light transmittance of the second coating film may affect the designability of the multilayer coating film. The average light transmittance of the second coating film at a wavelength of 400 to 700 nm is 50% or more. As a result, the tint of the first coating film is sensed through the second coating film. The average light transmittance of the second coating film may be 60% or more, and may be 70% or more. The average light transmittance of the second coating film is, for example, 95% or less.

The average light transmittance of the second coating film is measured not for a multilayer coating film but for a single second coating film. The single second coating film refers to a cured product of a film-like second coating composition. The single second coating film is obtained by spray-applying the second coating composition onto a polypropylene plate so as to have a dry film thickness of 10 to 20 μm (typically 15 μm), heating and curing the composition at 140° C. for 20 minutes, and then peeling the coating film from the polypropylene plate.

The light transmittance is measured for the single second coating film in a section of 400 to 700 nm under conditions of a wavelength scan mode, a scan speed of 60 nm/min, and a sampling interval of 2 nm using a spectrophotometer (for example, trade name: U-4100 manufactured by Hitachi, Ltd.). The arithmetic average value of the light transmittances obtained for every 10 nm is taken as the average light transmittance.

The chroma C2*₁₅ in the L*C*h color system based on the spectral reflectance of the reflected light R2₁₅ having received, at an angle of 15 degrees with respect to the specular light, the incident light I2₄₅ striking at an angle of 45 degrees with respect to a surface of a test coating film obtained by applying, onto a black article to be coated, the second coating composition may satisfy the relationship of:

$$C {2}_{15}^{*} \geq 5 .$$

That is, the second coating film itself can also have a chromatic tint in the highlight region. As a result, Cm*₁₅ of the multilayer coating film tends to be larger than 10.

C2*₁₅ may be 7 or more, and may be 10 or more. C2*₁₅ may be 50 or less, and may be 40 or less.

The black article to be coated includes a black portion in accordance with the black and white paper chart regulated in Section 3.2 of JIS K 5101-4:2004 “Test methods for pigments—Part 4: Hiding power—Black and white paper chart method”. Specifically, the black article to be coated is an approximately 174 mm×144 mm art paper having a white part and a black part with a solvent-resistant transparent coating material applied thereon, wherein the 45-degrees and 0-degrees diffusion reflectances are 80±1 in the white part and 2 or less in the black part.

The average light transmittance of the second coating film and the spectral reflectance of the reflected light R2₁₅ can be adjusted by, for example, the type and mass of the pigments contained in the second coating film and the thickness of the second coating film.

The content of the light interference pigment may be 0.5% to 20% by mass of the second coating film. As a result, the light transmittance of the second coating film and the spectral reflectance of the reflected light R2₁₅ are easily adjusted to the above ranges. In addition, when the content of the light interference pigment is 20% by mass or less, the surface of the second coating film tends to be smooth, and deterioration in the appearance of the multilayer coating film is inhibited.

The content of the light interference pigment may be 0.8% by mass or more, and may be 1.0% by mass or more. The content of the light interference pigment may be 15% by mass or less, may be 12% by mass or less, and may be 10% by mass or less.

The second coating film may further contain a coloring pigment. When the second coating film exhibits a color, color unevenness that may occur when the thickness of the first coating film and/or the second coating film is uneven is relieved.

The content of the coloring pigment may be 0.05% to 1.5% by mass of the second coating film from the viewpoint of not hindering light interference by the light interference pigment. The content of the coloring pigment may be 0.1% by mass or more, and may be 0.2% by mass or more. The content of the light coloring pigment may be 1.3% by mass or less, may be 1.0% by mass or less, and may be 0.9% by mass or less.

The mass ratio of the light interference pigment to the coloring pigment (light interference pigment/coloring pigment) may be 2 to 400. As a result, the development of the interference color by the light interference pigment is hardly hindered. The mass ratio may be 10 or more, and may be 20 or more. The mass ratio may be 300 or less, may be 200 or less, and may be 75 or less.

The primary particle size of the coloring pigment is not limited. The primary particle size of the coloring pigment may be 3 to 500 nm from the viewpoint that the development of the interference color by the light interference pigment is hardly hindered. The primary particle size can be measured from an electron microscope image of a section of the multilayer coating film using image processing software.

The thickness of the second coating film may be, for example, 3 to 23 μm. The thickness of the second coating film may be 7 μm or more. The thickness of the second coating film may be 20 μm or less, and may be 17 μm or less.

### Light Interference Pigment

The light interference pigment has a scaly substrate and a metal oxide covering the surface of the substrate. Since the substrate and the metal oxide are different in optical refractive index, multiple reflection of light occurs and an interference color appears. Light interference pigments are used singly or two or more of them are used in combination.

Examples of the substrate include mica, artificial mica, glass, silica, iron oxide, and aluminum oxide. Among them, mica, artificial mica, and aluminum oxide may be used.

The scaly form refers to a form having an aspect ratio (average major diameter/average thickness) of more than 1.0. The aspect ratio of the light interference pigment may be, for example, 20 to 300. The aspect ratio of the light interference pigment may be 30 or more. The aspect ratio of the light interference pigment may be 200 or less.

The average major diameter of the light interference pigment can be determined by observing the light interference pigment with a 3D laser scanning confocal microscope (for example, VK-X250 manufactured by Keyence Corporation), and averaging the major diameters (largest lengths) of 100 particles of light interference pigment arbitrarily chosen. The average thickness of the light interference pigment is obtained by observing a section of a coating film containing the light interference pigment using a transmission electron microscope (TEM), and averaging the thicknesses of arbitrarily selected 100 light interference pigments.

The average particle size of the light interference pigment is, for example, 3 to m. The average particle size of the light interference pigment may be 4 μm or more, and may be 5 μm or more. The average particle size of the light interference pigment may be 12 μm or less, and may be 10 μm or less.

The particle size is a 50% average particle size (D50) in a volume-based particle size distribution determined using a laser diffraction/scattering type particle size distribution analyzer. Examples of the particle size distribution analyzer include UPA-150 (Microtrac particle size distribution analyzer manufactured by Nikkiso Co., Ltd.).

Examples of the metal oxide include titanium oxide and iron oxide. The thickness of the metal oxide coating is not limited, and may be appropriately chosen according to a desired interference color. The interference color varies depending on the thickness of the coating. The chroma of the second coating film and the multilayer coating film may change depending on the thickness of the coating.

The light interference pigment may have been further subjected to a surface treatment for the purpose of improving dispersibility, water resistance, chemical resistance, weather resistance, and the like.

The light interference pigment is not limited as long as it exhibits the physical properties of the second coating film in the present disclosure. Specific examples of the light interference pigment include metal oxide-coated mica and metal oxide-coated alumina flakes.

Examples of commercially available products of the metal oxide-coated mica include “Ultimica” series and “TWINCLE PEARL” series manufactured by Nihon Koken Kogyo Co., Ltd., “Automotive” series manufactured by CQV Co., Ltd., “Lumina” series and “Magna Pearl” series manufactured by BASF SE, and “IRIODIN” series manufactured by Merck KGaA.

Examples of commercially available products of the metal oxide-coated alumina flakes include “Xirallic” series manufactured by Merck KGaA and “Adamas” series manufactured by CQV Co., Ltd.

### Coloring Pigment

The coloring pigment absorbs, reflects, or scatters light to impart a tint to the coating film. The coloring pigment may be either an inorganic substance or an organic substance. The coloring pigment may have either a chromatic color or an achromatic color. Examples of the organic coloring pigment include azo-chelate-based pigments, insoluble azo-based pigments, condensed azo-based pigments, diketopyrrolopyrrole-based pigments, phthalocyanine-based pigments, indigo pigments, perinone-based pigments, perylene-based pigments, dioxane-based pigments, quinacridone-based pigments, isoindolinone-based pigments, and metal complex pigments. Examples of the inorganic coloring pigment include chrome yellow, yellow iron oxide, red iron oxide, carbon black, and titanium dioxide. These are used singly or two or more of them are used in combination.

### (Clear Coating Film)

The clear coating film protects the first and second coating films. The clear coating film is typically a cured product of a clear coating composition.

The thickness of the clear coating film may be, for example, 10 to 80 μm. The thickness of the clear coating film may be 20 μm or more. The thickness of the clear coating film may be 50 μm or less.

### (Chroma and Lightness of Multilayer Coating Film)

The chroma Cm*₁₅ may be 12 or more, and may be 13 or more. Cm*₁₅ may be 50 or less, may be 40 or less, and may be 35 or less.

The chroma Cm*₄₅ may be 10 or less, and may be 9.0 or less. Cm*₄₅ may be 1.0 or more, and may be 1.1 or more.

Cm*₁₅-Cm*₄₅ may be 5.5 or more, and may be 6.0 or more. Cm*₁₅-Cm*₄₅ may be 50 or less, may be 40 or less, and may be 30 or less.

Lm*₄₅ is, for example, 30 to 65. As a result, the multilayer coating film is sensed in a gray color in the face region. Lm*₄₅ may be 32 or more, and may be 35 or more. Lm*₄₅ may be 65 or less, and may be 62 or less.

### [Coated Article]

The coated article according to the present disclosure includes an article to be coated and the above-described multilayer coating film disposed on the article to be coated. In the coated article, the clear coating film is disposed outside. A coated article having the multilayer coating film has an unprecedented design in which a chromatic tint is sensed in a highlight region while exhibiting a calm gray color in a face region.

### (Article to be Coated)

Examples of the material of the article to be coated include metal, plastic, and foam. In particular, the metal may be a metal (especially, a cast) and may be a metal capable of being coated by electrodeposition. Examples of such metal include metals such as iron, copper, aluminum, tin, and zinc, and alloys containing such metals.

The form of the article to be coated is not limited, and may be a flat plate form and may be three-dimensionally molded. Examples of the article to be coated specifically include bodies of automobile such as passenger cars, trucks, motorcycles, and buses, and parts of automobile bodies.

The metallic article to be coated may have been subjected to chemical conversion treatment using a phosphoric acid-based chemical conversion treatment agent, a zirconium-based chemical conversion treatment agent, or the like, and electrodeposition coating. The electrodeposition coating composition may be either of a cationic type or of an anionic type. The cationic electrodeposition coating composition can form a coating film superior in anticorrosion property.

The metallic article to be coated may include an electrodeposition coating film and an intermediate coating film disposed thereon. The intermediate coating film is usually provided for the purpose of improving the adhesion and durability of a multilayer coating film. The intermediate coating composition may include, for example, a coating film-forming resin, a curing agent, a coloring pigment, and an extender pigment.

Examples of the coating film-forming resin and the curing agent include those the same as those contained in the first coating composition.

### [Method for Producing Coated Article]

The method for producing a coated article according to the present disclosure includes: applying a first coating composition onto an article to be coated to form a first coating film; applying a second coating composition containing a light interference pigment onto the first coating film to form a second coating film; and applying a clear coating composition onto the second coating film to form a clear coating film.

In one embodiment, the coated article is produced by sequentially applying the first coating composition and the second coating composition to the article to be coated, then curing the coating compositions, and then applying and curing the clear coating composition. After the application of the first coating composition, preheating may be performed before the application of the second coating composition.

In another embodiment, a coated article is produced by sequentially wet-on-wet applying a first coating composition, a second coating composition, and a clear coating composition on an article to be coated, and then curing these coating compositions at a time. After the application of the first coating composition and before the application of the second coating composition, and after the application of the second coating composition and before the application of the clear coating composition, preheating may be performed.

Examples of an application method include multistage application, preferably two-stage application, using air-spray application, airless-spray application, electrostatic spray application, or air-electrostatic spray application, or application combining air-electrostatic spray application and a rotary atomization type electrostatic applicator.

Curing of each coating composition is performed, for example, under conditions of a heating temperature of 80° C. to 180° C. (preferably 100° C. to 160° C.) and a heating time of 5 minutes to 60 minutes (preferably 10 minutes to 30 minutes).

### (First Coating Composition)

The first coating composition contains a pigment that adjusts lightness (typically, white and black pigments) and a coating film-forming resin.

The first coating composition may be either aqueous or solvent-based. The aqueous first coating composition may contain water and, as necessary, a water-soluble or water-miscible organic solvent as a main solvent. The solvent-based first coating composition may contain, for example, an ester-based solvent, an ether-based solvent, an alcohol-based solvent, a ketone-based solvent, an aliphatic hydrocarbon-based solvent, or an aromatic solvent as a main solvent. The first coating composition can be diluted with a solvent suitable for coating and used. The first coating composition may be aqueous. The main solvent accounts for 50% by mass or more of the total solvent.

### <<White Pigment>>

The white pigment is not limited. Examples of the white pigment include titanium dioxide, zinc oxide, and silica. These are used singly or two or more of them are used in combination. Titanium dioxide is employable from the viewpoint that this is high in refractive index. Titanium dioxide may be either a rutile type or an anatase type. Among them, rutile-type titanium dioxide is employable from the viewpoint of weather resistance. The surface of the titanium dioxide may have been treated with an inorganic compound such as silica, zirconium, or aluminum.

The primary particle size of the white pigment is not limited. From the viewpoint of hiding property, the primary particle size of the white pigment may be 100 to 500 nm, and may be 200 to 400 nm.

The blending amount of the white pigment is not limited. The white pigment is blended such that the following relationship is satisfied:

$$C {1}_{45}^{*} \leq 15$$

$$20 \leq L {1}_{45}^{*} \leq 70 .$$

Specifically, the blending amount of the white pigment may be 10% to 50% by mass of the first coating film. The blending amount of the white pigment may be 20% by mass or more of the first coating film, and may be 30% by mass or more. The blending amount of the white pigment may be 45% by mass or less of the first coating film, and may be 40% by mass or less.

### <<Black Pigment>>

The black pigment is not limited. Examples of the black pigment include carbon black; composite metal oxides such as iron chromium and bismuth manganese; perylene pigments; and azomethyazo pigments. These are used singly or two or more of them are used in combination. The black pigment may be carbon black.

The primary particle size of the black pigment is not limited. From the viewpoint of hiding property, the primary particle size of the black pigment may be 20 to 70 nm, and may be 30 to 60 nm.

The blending amount of the black pigment is not limited. The black pigment is blended such that the following relationship is satisfied:

$$C {1}_{45}^{*} \leq 15 \\ 20 \leq L {1}_{45}^{*} \leq 70.$$

Specifically, the blending amount of the black pigment may be 0.5% to 5% by mass of the first coating film. The blending amount of the black pigment may be 1% by mass or more of the first coating film, and may be 2% by mass or more. The blending amount of the black pigment may be 4% by mass or less of the first coating film, and may be 3% by mass or less.

The blending ratio of the white pigment to the black pigment (white:black) may be, for example, 50:1 to 20:1 in mass ratio. The blending ratio (white:black) may be 40:1 to 30:1.

### <<Coating Film-Forming Resin>>

Examples of the coating film-forming resin include an acrylic resin, an acrylic silicone resin, a polyester resin, a polyurethane resin, an epoxy resin, a fluororesin, and a silicone resin. These are used singly or two or more of them are used in combination. Among them, an acrylic resin may be used.

In an aqueous first coating composition, these resins may be contained in the form of an emulsion, may be contained in the form of a dispersion, and may be contained in a state of being dissolved in a solvent.

For example, an acrylic resin emulsion can be prepared by emulsion polymerization of an α,β-ethylenically unsaturated monomer. Examples of the α,β-ethylenically unsaturated monomer include a (meth)acrylic acid ester, an α,β-ethylenically unsaturated monomer having an acid group, and an α,β-ethylenically unsaturated monomer having a hydroxy group. Such monomers are used singly or two or more of them are used in combination.

Examples of the (meth)acrylic acid ester include methyl (meth)acrylate, ethyl (meth)acrylate, propyl (meth)acrylate, n-butyl (meth)acrylate, isobutyl (meth)acrylate, t-butyl (meth)acrylate, 2-ethylhexyl (meth)acrylate, lauryl methacrylate, phenyl (meth)acrylate, isobornyl (meth)acrylate, cyclohexyl (meth)acrylate, t-butylcyclohexyl (meth)acrylate, dicyclopentadienyl (meth)acrylate, and dihydrodicyclopentadienyl (meth)acrylate). The (meth)acrylic acid ester represents an acrylic acid ester and a methacrylic acid ester.

Examples of the α,β-ethylenically unsaturated monomer having an acid group include acrylic acid, methacrylic acid, crotonic acid, 2-acryloyloxyethylphthalic acid, 2-acryloyloxyethylsuccinic acid, ω-carboxy-polycaprolactone mono(meth)acrylate, isocrotonic acid, α-hydro-ω-((1-oxo-2-propenyl)oxy) poly(oxy(1-oxo-1,6-hexanediyl)), maleic acid, fumaric acid, itaconic acid, 3-vinylsalicylic acid, 3-vinylacetylsalicylic acid, 2-acrylamido-2-methylpropanesulfonic acid, p-hydroxystyrene, and 2,4-dihydroxy-4′-vinylbenzophenone.

Examples of the α,β-ethylenically unsaturated monomer having a hydroxy group include hydroxyethyl (meth)acrylate, hydroxypropyl (meth)acrylate, hydroxybutyl (meth)acrylate, allyl alcohol, methallyl alcohol, and adducts of these with F-caprolactone.

Another α,β-ethylenically unsaturated monomer may be used in combination. Examples of the other α,β-ethylenically unsaturated monomer include a polymerizable amide compound, a polymerizable aromatic compound, a polymerizable nitrile, a polymerizable alkylene oxide compound, a polyfunctional vinyl compound, a polymerizable amine compound, an α-olefin, a diene, a polymerizable carbonyl compound, a polymerizable alkoxysilyl compound, and other polymerizable compounds.

The method of emulsion polymerization is not limited. For example, an emulsifier is dissolved in water or an aqueous medium containing an organic solvent such as an alcohol, an ether (for example, dipropylene glycol methyl ether or propylene glycol methyl ether) as necessary, and an α,β-ethylenically unsaturated monomer and a polymerization initiator are added dropwise under heating and stirring. The α,β-ethylenically unsaturated monomer may be emulsified in advance with an emulsifier.

As the polymerization initiator and the emulsifier, those commonly used by those skilled in the art can be used. As necessary, the molecular weight may be adjusted using a chain transfer agent such as a mercaptan (for example, lauryl mercaptan) or α-methylstyrene dimer. The reaction temperature, the reaction time, and so on may be appropriately selected within ranges commonly used by those skilled in the art. The acrylic resin emulsion obtained is neutralized with a base, as necessary.

The acrylic resin (emulsion of acrylic resin) obtained by emulsion polymerization may have a number average molecular weight of 3,000 or more. The acrylic resin may have a hydroxyl value (solid hydroxyl value) of 20 to 180 mg KOH/g. The acrylic resin may have an acid value (solid acid value) of 1 to 80 mg KOH/g.

The number average molecular weight is determined in a GPC method using polystyrene as a standard. The acid value and the hydroxyl value of the coating film-forming resin are calculated from the monomer composition used for the preparation, on the basis of the JIS regulation.

The acrylic resin dispersion can be prepared, for example, by solution-polymerizing the α,β-ethylenically unsaturated monomer and dispersing the resultant using a basic compound.

A water-soluble acrylic resin can be prepared, for example, by solution-polymerizing the α,β-ethylenically unsaturated monomer described above and solubilizing the resultant in water using a basic compound.

An acrylic resin to be blended in a solvent-based first coating composition can be prepared, for example, by solution-polymerizing an α,β-ethylenically unsaturated monomer. The acrylic resin has a number average molecular weight of, for example, 1,000 to 20,000. The acrylic resin may have an acid value (solid acid value) of 1 to 80 mg KOH/g. The acrylic resin may have a hydroxyl value (solid hydroxyl value) of 101 to 200 mg KOH/g.

### <<Curing Agent>>

The first coating composition may contain a curing agent. The curing agent reacts with the coating film-forming resin to form a first coating film together with the coating film-forming resin.

Examples of the curing agent include a melamine resin, a blocked isocyanate compound, an epoxy compound, an aziridine compound, a carbodiimide compound, an oxazoline compound, and a metal ion. These are used singly or two or more of them are used in combination. Among them, at least one of the melamine resin and the blocked isocyanate compound may be used.

The melamine resin may be either soluble in water or insoluble in water. The melamine resin has a structure in which a hydrogen atom or a substituent (alkyl ether group, methylol group, or the like) is bonded around a melamine nucleus (triazine nucleus) with three nitrogen atoms interposed therebetween. The melamine resin is generally composed of a polynuclear body in which a plurality of melamine nuclei is bonded together. Alternatively, the melamine resin may be a mononuclear body composed of a single melamine nucleus.

A commercially available melamine resin may be used. Examples of a commercially available melamine resin include the CYMEL series (trade name) manufactured by Allnex GMBH, specifically, CYMEL 202, CYMEL 204, CYMEL 211, CYMEL 232, CYMEL 235, CYMEL 236, CYMEL 238, CYMEL 250, CYMEL 251, CYMEL 254, CYMEL 266, CYMEL 267, CYMEL 272, CYMEL 285, CYMEL 301, CYMEL 303, CYMEL 325, CYMEL 327, CYMEL 350, CYMEL 370, CYMEL 701, CYMEL 703, CYMEL 1141; and the U-VAN (trade name) series manufactured by Mitsui Chemicals, Inc. These are used singly or two or more of them are used in combination.

The blocked isocyanate compound can be prepared by adding a blocking agent having an active hydrogen to polyisocyanate such as trimethylene diisocyanate, hexamethylene diisocyanate, xylylene diisocyanate, and isophorone diisocyanate.

The content of the curing agent may be 10% to 80% mass of the resin solid content contained in the first coating composition. The content of the curing agent may be 15% by mass or more. The content of the curing agent may be 60% by mass or less.

The first coating composition is prepared by kneading and dispersing a white pigment, a black pigment, a coating film-forming resin, a curing agent, etc. using a disper, a homogenizer, a kneader, or the like. A pigment paste may be prepared in advance using a pigment such as a white pigment and a black pigment and a pigment dispersant, and this may be mixed with a coating film-forming resin or the like.

### <<Other Pigments>>

The first coating composition (first coating film) may further contain a pigment other than the white pigment and the black pigment. Examples of such other pigments include chromatic color pigments, extender pigments, rust-proof pigments, and luster pigments (including light interference pigments). The other pigments are blended as long as neither the properties nor the functions of the first coating film are hindered.

### <<Additives>>

The first coating composition may contain an additive commonly used by those skilled in the art. Examples of the additive include a surface conditioning agent, a viscosity controlling agent, a thickening agent, an ultraviolet blocking agent, and an antifoaming agent, and.

### (Second Coating Composition)

The second coating composition contains a light interference pigment and a coating film-forming resin. The second coating composition may further contain a coloring pigment.

The second coating composition may be either aqueous or solvent-based. The second coating composition may be aqueous. The solvent contained in the second coating composition and the preparation method thereof are the same as those of the first coating composition.

### <<Coating Film-Forming Resin>>

Examples of the coating film-forming resin include those recited as examples of that contained in the first coating composition. The coating film-forming resins contained in the first and second coating compositions may be the same or different. In addition, the second coating composition may contain the same components as those of the first coating composition.

### <<Other Pigments>>

The second coating film may further contain a pigment other than the light interference pigment. Examples of such other pigment include coloring pigments (including white pigments and black pigments), extender pigments, rust-proof pigments, luster pigments other than light interference pigments. The other pigments are blended as long as neither the properties nor the functions of the second coating film are hindered.

### <<Phosphoric Acid Group-Containing Organic Compound>>

The second coating composition may further contain a phosphoric acid group-containing organic compound. The phosphoric acid group-containing compound makes the dispersibility of a scaly pigment (for example, a light interference pigment) to be easily improved.

The content of the phosphoric acid group-containing compound may be 0.1% to 15% by mass of the entire solid content of the second coating composition. The content of the phosphoric acid group-containing compound may be 1% by mass or more. The content of the phosphoric acid group-containing compound may be 12% by mass or less.

The phosphoric acid group-containing compound is not limited as long as it has a phosphoric acid group (—P(═O)(OR)₂ (R is each independently hydrogen or a hydrocarbon group). The phosphoric acid group-containing compound is, for example, at least one of an alkyl phosphate having an alkyl group having 4 to 30 carbon atoms and a phosphoric acid group-containing polymer having a phosphoric acid group value of 5 to 300 mg KOH/g.

### <Alkyl Phosphate Ester>

The alkyl phosphate has an alkyl group having 4 to 30 carbon atoms. Examples of the alkyl phosphate include a monoalkyl phosphate, a dialkyl phosphate, and mixtures thereof. In the dialkyl phosphate, the two alkyl groups may be the same or different. The dialkyl phosphate preferably has the same two alkyl groups.

Examples of the alkyl group having 4 to 30 carbon atoms include a butyl group, a pentyl group, a hexyl group, a heptyl group, an octyl group, a nonyl group, a decyl group, an undecyl group, a dodecyl group, a tridecyl group, a tetradecyl group, a pentadecyl group, a hexadecyl group, a heptadecyl group, an octadecyl group, a nonadecyl group, an eicosyl group, a docosyl group, a tetracosyl group, a hexacosyl group, and an octacosyl group. The alkyl group may be linear or branched.

Examples of the alkyl phosphate include butyl acid phosphate (a mixture of monobutyl phosphate and dibutyl phosphate), 2-ethylhexyl acid phosphate (a mixture of mono-2-ethylhexyl phosphate and di-2-ethylhexyl phosphate), isodecyl acid phosphate (a mixture of monoisodecyl phosphate and diisodecyl phosphate), dilauryl acid phosphate, lauryl acid phosphate (a mixture of monolauryl phosphate and dilauryl phosphate), tridecyl acid phosphate (a mixture of monotridecyl phosphate and ditridecyl phosphate), monostearyl acid phosphate, distearyl acid phosphate, and stearyl acid phosphate (a mixture of monostearyl phosphate and distearyl phosphate), isostearyl acid phosphate (a mixture of monoisostearyl phosphate and diisostearyl phosphate), oleyl acid phosphate (a mixture of monooleyl phosphate and dioleyl phosphate), and behenyl acid phosphate (a mixture of monobehenyl phosphate and dibehenyl phosphate).

### <Phosphoric Acid Group-Containing Polymer>

The phosphoric acid group-containing polymer has a phosphoric acid group value of 5 to 300 mg KOH/g. The phosphoric acid group value of the phosphoric acid group-containing polymer may be 10 mg KOH/g or more, and may be 50 mg KOH/g or more. The phosphoric acid group value of the phosphoric acid group-containing polymer may be 250 mg KOH/g or less, and may be 150 mg KOH/g or less.

The phosphoric acid group value is the amount in mg of potassium hydroxide (KOH) required for neutralization, which is calculated on the basis of the blending amount of a phosphoric acid group-containing component such as a phosphoric acid ester used for the preparation of the phosphoric acid group-containing polymer.

The number average molecular weight of the phosphoric acid group-containing polymer is, for example, 1,000 to 50,000. The number average molecular weight of the phosphoric acid group-containing polymer may be 3,000 or more and 5,000 or more. The number average molecular weight of the phosphoric acid group-containing polymer may be 30,000 or less, and may be 20,000 or less.

Examples of the phosphoric acid group-containing polymer include an acrylic resin, a polyester resin, a polyether resin, and an epoxy resin having a phosphoric acid group value of 5 to 300 mg KOH/g. These are used singly or two or more of them are used in combination. Among them, the phosphoric acid group-containing polymer may be a phosphoric acid group-containing acrylic resin. The phosphoric acid group-containing acrylic resin is obtained, for example, by polymerizing a phosphoric acid group-containing α,β-ethylenically unsaturated monomer or copolymerizing this monomer with another α,β-ethylenically unsaturated monomer free from a phosphoric acid group.

### <<Additives>>

The second coating composition may contain an additive commonly used by those skilled in the art. Examples of the additive include those recited as examples of that contained in the first coating composition.

### (Clear Coating Composition)

The clear coating composition may be a solvent-based composition, may be an aqueous composition, and may be a powder type composition. The clear coating composition may be a solvent-based composition.

The clear coating composition may be, for example, an acid epoxy curable type containing a polyepoxide and a polycarboxylic acid, or a urethane curable type containing a hydroxy group-containing resin and a polyisocyanate curing agent. The urethane curable clear coating composition may be a two-pack type.

The acid epoxy curable type clear coating composition contains, for example, an acid anhydride group-containing acrylic resin (a), a carboxyl group-containing polyester resin (b), and an acrylic resin (c) having a hydroxy group and an epoxy group. From the viewpoint of storage stability, the acid anhydride group of the acid anhydride group-containing acrylic resin (a) may have been half-esterified with a low molecular weight alcohol or the like. The carboxyl group-containing polyester resin (b) may further have a hydroxy group.

The resins (a) to (c) are blended such that, for example, the molar ratio of carboxyl groups contained in the acrylic resin (a) and the polyester resin (b) to epoxy groups contained in the acrylic resin (c) is 1/1.4 to 1/0.6 (preferably 1/1.2 to 1/0.8), and the molar ratio of carboxyl groups derived from acid anhydride groups contained in the acrylic resin (a) to hydroxy groups contained in the polyester resin (b) and the acrylic resin (c) is 1/2.0 to 1/0.5 (preferably 1/1.5 to 1/0.7).

The urethane curable type clear coating composition contains, for example, a hydroxy group-containing resin and a polyisocyanate curing agent. Examples of the polyisocyanate curing agent include aliphatic isocyanates such as trimethylene diisocyanate, tetramethylene diisocyanate, pentamethylene diisocyanate, hexamethylene diisocyanate (HDI), and trimethylhexamethylene diisocyanate; aliphatic cyclic isocyanates such as 1,3-cyclopentane diisocyanate, 1,4-cyclohexane diisocyanate, and 1,2-cyclohexane diisocyanate; aromatic isocyanates such as xylylene diisocyanate (XDI), 2,4-tolylene diisocyanate (TDI), and 2,6-tolylene diisocyanate; alicyclic isocyanates such as isophorone diisocyanate (IPDI) and norbornane diisocyanate; multimers such as biuret type and nurate type of these isocyanates; and mixtures thereof.

The hydroxyl value of the hydroxy group-containing resin is, for example, 20 to 200 mg KOH/g. The hydroxyl value may be 30 mg KOH/g or more. The hydroxyl value may be 180 mg KOH/g or less. The weight average molecular weight of the hydroxy group-containing acrylic resin is, for example, 1000 to 20000. The weight average molecular weight may be 2000 or more. The weight average molecular weight may be 15000 or less. The acid value of the hydroxy group-containing resin is, for example, 2 to 30 mg KOH/g. The acid value may be 3 mg KOH/g or more. The acid value may be 25 mg KOH/g or less.

The hydroxy group-containing resin and the polyisocyanate curing agent are blended such that, for example, an equivalent ratio of isocyanate groups (NCO) to hydroxy groups (OH) (NCO/OH) is 0.5 to 1.7. The equivalent ratio may be 0.7 or more. The equivalent ratio may be 1.5 or less.

In addition, an acrylic melamine curable type clear coating composition may be used.

### EXAMPLES

The present invention will be described hereafter in more detail by way of examples, to which the present invention is not intended to be limited. In the examples, “parts” and “%” are on a mass basis unless otherwise indicated.

The measurement of the number average molecular weight was performed using “HLC8220GPC” (trade name) (manufactured by Tosoh Corporation) as a GPC device and four columns “Shodex F-606M” (trade name) and “Shodex KF-603” (trade name) (both manufactured by Showa Denko K.K.) under the conditions of a mobile phase: tetrahydrofuran, a measurement temperature: 40° C., a flow rate: 0.6 cc/min, and a detector: RI.

The phosphoric acid group value is the amount in mg of potassium hydroxide (KOH) required for neutralization, which is calculated on the basis of the blending amount of a phosphoric acid group-containing component such as a phosphoric acid ester used for the preparation of the phosphoric acid group-containing polymer. The acid value and the hydroxyl value were calculated from the monomer composition used for the preparation, on the basis of the JIS regulation.

### [Production Example 1] Production of Acrylic Resin Emulsion

633 parts of deionized water was added to a reaction vessel, and was heated to 80° C. while being mixed and stirred in a nitrogen stream. Separately, 75.65 parts of styrene (ST), 178.96 parts of methyl methacrylate (MMA), 75.94 parts of n-butyl acrylate (BA), 64.45 parts of 2-ethylhexyl acrylate (2-EHA), and 105.0 parts of hydroxyethyl methacrylate (HEMA) were mixed to prepare a monomer mixture of the first stage. Subsequently, this monomer mixture, 25.0 parts of AQUALON HS-10(polyoxyethylene alkylpropenylphenyl ether sulfuric acid ester, manufactured by DKS Co., Ltd.), 25.0 parts of ADEKA REASOAP NE-20 (α-[1-[(allyloxy)methyl]-2-(nonylphenoxy)ethyl]-o-hydroxyoxyethylene, manufactured by ADEKA Corporation), and 400 parts of deionized water were mixed to prepare a monomer emulsion. Separately, an initiator solution composed of 1.2 parts of ammonium persulfate and 500 parts of deionized water was prepared. The monomer emulsion and the initiator solution were dropped to the reaction vessel in parallel over 1.5 hours. After the completion of the dropping, aging was carried out at that temperature for 1 hour.

Further, separately, 53.65 parts of styrene (ST), 178.96 parts of methyl methacrylate (MMA), 75.94 parts of n-butyl acrylate (BA), 64.45 parts of 2-ethylhexyl acrylate (2-EHA), 105.0 parts of hydroxyethyl methacrylate (HEMA), and 22 parts of acrylic acid were mixed to prepare a monomer mixture of the second stage. Subsequently, this monomer mixture, 10 parts of AQUALON HS-10, and 250 parts of deionized water were mixed to prepare a monomer emulsion. Separately, an initiator solution composed of 3.0 parts of ammonium persulfate and 500 parts of deionized water was prepared. The monomer emulsion and the initiator solution were dropped to the reaction vessel in parallel over 1.5 hours. After the completion of the dropping, aging was carried out at that temperature for 2 hours.

Subsequently, the reaction mixture was cooled to 40° C. and was filtered through a 400 mesh filter. Finally, 100 parts of deionized water and 1.6 parts of dimethylaminoethanol were added to the reaction mixture to adjust the pH to 6.5. In this way, an acrylic resin emulsion having an average particle size of 150 nm, a solid concentration of 35%, a solid acid value of 20 mg KOH/g, and a hydroxyl value of 100 mg KOH/g was obtained.

### [Production Example 2] Production of Phosphoric Acid Group-Containing Polymer

A 1-liter reaction vessel equipped with a stirrer, a thermostat, and a cooling tube was charged with 40 parts of ethoxypropanol. Separately, 20 parts of Phosmer PP (acid phosphooxyhexa(oxypropylene) monomethacrylate manufactured by Uni-Chemical Co., Ltd.) was dissolved in 20 parts of ethoxypropanol to prepare a solution. 40 parts of this solution, 4 parts of styrene, 35.96 parts of n-butyl acrylate, 18.45 parts of ethylhexyl methacrylate, 13.92 parts of 2-hydroxyethyl methacrylate, 7.67 parts of methacrylic acid, and 1.7 parts of azobisisobutyronitrile were mixed to prepare a monomer solution. 121.7 parts of the monomer solution was dropped to the reaction vessel at 120° C. over 3 hours. The mixture was further stirred for 1 hour, affording a phosphoric acid group-containing polymer. The phosphoric acid group-containing polymer obtained in this way had an acid value of 105 mg KOH/g, a phosphoric acid group value of 55 mg KOH/g, a hydroxyl value of 60 mg KOH/g, a number average molecular weight of 6,000, and a solid concentration of 63%.

### [Production Example 3] Production of Water-Soluble Acrylic Resin

23.89 parts of tripropylene glycol methyl ether and 16.11 parts of propylene glycol methyl ether were added to a reaction vessel, and the temperature was raised to 105° C. while mixing and stirring in a nitrogen stream. Subsequently, a monomer mixture of 13.1 parts of methyl methacrylate, 68.4 parts of ethyl acrylate, 11.6 parts of 2-hydroxyethyl methacrylate, and 6.9 parts of methacrylic acid was prepared, and 100 parts of the monomer mixture and an initiator solution composed of 10.0 parts of tripropylene glycol methyl ether and 1 part of tert-butyl peroxy-2-ethylhexanoate were dropped in parallel into the reaction vessel over 3 hours. After the completion of the dropping, aging was carried out at that temperature for 0.5 hours.

Furthermore, an initiator solution composed of 5.0 parts of tripropylene glycol methyl ether and 0.3 parts of tert-butyl peroxy-2-ethylhexanoate was dropped into the reaction vessel over 0.5 hours. After the completion of the dropping, aging was carried out at that temperature for 2 hours.

After removing 16.1 parts of the solvent at 110° C. under reduced pressure (70 torr) with a desolvating apparatus, 204 parts of deionized water and 7.1 parts of dimethylaminoethanol were added to obtain a water-soluble acrylic resin solution. The water-soluble acrylic resin solution obtained had a solid concentration of 30%, a solid acid value of 40 mg KOH/g, a hydroxyl value of 50 mg KOH/g, and a viscosity of 140 poise (E-type viscometer, 1 rpm/25° C.).

### Example 1

### (1) Preparation of First Coating Composition

### (1-1) Preparation of Coloring Pigment Dispersion A1

10 parts of the water-soluble acrylic resin solution of Production Example 3, 48 parts of a white pigment (titanium dioxide), 0.3 parts of a black pigment (carbon black), 2.5 parts of a pigment dispersant (trade name: DISPEX ULTRA PA 4550AN), 40 parts of ion-exchanged water, and 0.5 parts of an antifoaming agent (trade name: BYK-011) were mixed with a stirrer. Subsequently, the mixture was dispersed using a dispersing device packed with 0.05 mm zirconia beads in a volume packing ratio of 70%, affording a coloring pigment dispersion A1.

### (1-2) Preparation of First Coating Composition

90 parts of the acrylic resin emulsion of Production Example 1, 2.0 parts of dimethylaminoethanol, 28.4 parts of a melamine resin (trade name: CYIEL 370N, mixed alkylated melamine resin, manufactured by Allnex, solid content: 90%), 100 parts of the coloring pigment dispersion A1, 50 parts of butyl cellosolve, 5.5 parts (3 parts in terms of solid content) of a surfactant (trade name: NOIGEN EA-207D, manufactured by DKS Co., Ltd., number average molecular weight: 4200, solid content: 55%), and 3 parts of linoleic acid (manufactured by Kishida Chemical Co., Ltd.) were uniformly dispersed. Dimethylaminoethanol was added to the dispersion such that the pH was adjusted to 8.1, and then the resulting mixture was diluted with deionized water, affording an aqueous first coating composition having a total solid concentration of 25%.

### (2) Preparation of Second Coating Composition

100 parts of the acrylic resin emulsion of Production Example 1, 1.4 parts of dimethylaminoethanol, 28.4 parts of the melamine resin (trade name: CYMEL 370N), 1.7 parts of a light interference pigment A (trade name: Xirallic T60-23, manufactured by MERCK), 1.7 parts of a light interference pigment C (trade name: Xirallic T60-25, manufactured by MERCK), 5 parts of the phosphoric acid group-containing polymer of Production Example 2, 0.4 parts of lauryl acid phosphate, 50 parts of butyl cellosolve, 5.5 parts (3 parts in terms of solid content) of the surfactant (trade name: NOIGEN EA-207D), and 3 parts of linoleic acid (manufactured by Kishida Chemical Co., Ltd.) were uniformly dispersed. Dimethylaminoethanol was added to the dispersion such that the pH was adjusted to 8.1, and then the resulting mixture was diluted with deionized water to prepare an aqueous second coating composition having a total solid concentration of 25%.

### (3) Preparation of Clear Coating Composition

As a clear coating composition, an acid epoxy curable type clear coating material (trade name: MACFLOW 0-1810 Clear, manufactured by Nippon Paint Automotive Coatings Co., Ltd.) was prepared.

### (4) Formation of Multilayer Coating Film

A cationic electrodeposition coating composition “Power Top U-50” (manufactured by Nippon Paint Automotive Coatings Co., Ltd.) was applied to a dull steel sheet treated with zinc phosphate and having a thickness of 0.8 mm, a length of 30 cm, and a width of 40 cm by electrodeposition coating such that a dry film thickness was 20 m, and then was baked at 160° C. for 30 minutes. To the resulting coated sheet, an intermediate coating composition “OP-30P Middle Gray” (polyester-melamine-based coating material manufactured by Nippon Paint Automotive Coatings Co., Ltd., diluted in advance for 25 seconds (measured at 20° C. using No. 4 Ford cup)) was air-spray applied with an air spray gun W-101-132G manufactured by ANEST IWATA Corporation such that the dry film thickness was 35 μm, and then heated at 140° C. for 30 minutes. In this way, an article to be coated having an electrodeposition coating film and an intermediate coating film was obtained.

The first coating composition was air-spray applied to the article to be coated under conditions of a room temperature of 23° C. and a humidity of 68% such that the dry film thickness was 10 μm. Following setting for 1.5 minutes, the second coating composition was air-spray applied wet-on-wet under conditions of a room temperature of 23° C. and a humidity of 68% such that the dry film thickness was 10 μm. After setting for 3 minutes, preheating was performed at 80° C. for 3 minutes. The coated plate was allowed to cool to room temperature, and a clear coating composition was air-spray applied so as to have a dry film thickness of 35 μm, followed by setting for 7 minutes. Finally, the coated plate was heated at 140° C. for 30 minutes with a dryer, affording a coated article with a multilayer coating film.

### Example 2

### (1) Preparation of First Coating Composition

A coloring pigment dispersion A2 was prepared in the same manner as in Example 1 except that 49 parts of the white pigment (titanium dioxide) and 0.2 parts of the black pigment (carbon black) were mixed. A first coating composition was prepared in the same manner as in Example 1 except that the coloring pigment dispersion A2 was used instead of the coloring pigment dispersion A1.

### (2) Preparation of Second Coating Composition

A second coating composition was prepared in the same manner as in Example 1 except that 8.5 parts of a light interference pigment F (trade name: BXC-SO, manufactured by Nihon Koken Kogyo Co., Ltd.) was blended instead of the light interference pigment A, and the blending amount of the light interference pigment C was changed to 10.2 parts.

A multilayer coating film and a coated article were obtained in the same manner as in Example 1 except that the first coating composition and the second coating composition described above were used.

### Example 3

### (2) Preparation of Second Coating Composition

A second coating composition was prepared in the same manner as in Example 1 except that 8.5 parts of a light interference pigment B (trade name: Xirallic T60-20, manufactured by MERCK) and 8.5 parts of another luster pigment a (trade name: GT1020RSJ3, manufactured by Nippon Sheet Glass Co., Ltd.) were used instead of the light interference pigments A and C.

A multilayer coating film and a coated article were obtained in the same manner as in Example 1 except that the second coating composition described above was used.

### Example 4

### (1) Preparation of First Coating Composition

A coloring pigment dispersion A4 was prepared in the same manner as in Example 1 except that 35 parts of the white pigment (titanium dioxide), 1.3 parts of the black pigment (carbon black), 1.5 parts of a coloring pigment 3 (Quinacridone Red, trade name: Rubicron 400RG, manufactured by DIC Corporation), and 0.8 parts of a coloring pigment 4 (Cyanine Blue, trade name: Cyanine Blue G-314R, manufactured by Sanyo Color Works, Ltd.) were mixed. A first coating composition was prepared in the same manner as in Example 1 except that the coloring pigment dispersion A4 was used instead of the coloring pigment dispersion A1.

### (2) Preparation of Second Coating Composition

### (2-1) Preparation of Coloring Pigment Dispersion B1

10 parts of the water-soluble acrylic resin solution of Production Example 3, 35 parts of a coloring pigment 1 (titanium dioxide), 2.5 parts of a coloring pigment 2 (carbon black), 0.3 parts of the coloring pigment 3, 0.3 parts of the coloring pigment 4, 3 parts of the pigment dispersant (trade name: DISPEX ULTRA PA 4550AN), 47.6 parts of ion-exchanged water, and 1 part of the antifoaming agent (trade name: BYK-011) were mixed with a stirrer. Subsequently, the mixture was dispersed using a dispersing device packed with 0.05 mm zirconia beads in a volume packing ratio of 70%, affording a coloring pigment dispersion B1.

### (2-2) Preparation of Second Coating Composition

100 parts of the acrylic resin emulsion of Production Example 1, 1.4 parts of dimethylaminoethanol, 28.4 parts of the melamine resin (trade name: CYMEL 370N), 1.7 parts of the light interference pigment A, 2.3 parts of the coloring pigment dispersion B1, 5 parts of the phosphoric acid group-containing polymer of Production Example 2, 0.4 parts of lauryl acid phosphate, 50 parts of butyl cellosolve, 5.5 parts (3 parts in terms of solid content) of the surfactant (trade name: NOIGEN EA-207D), and 3 parts of linoleic acid (manufactured by Kishida Chemical Co., Ltd.) were uniformly dispersed. Dimethylaminoethanol was added to the dispersion such that the pH was adjusted to 8.1, and then the resulting mixture was diluted with deionized water to prepare an aqueous second coating composition having a total solid concentration of 25%.

A multilayer coating film and a coated article were obtained in the same manner as in Example 1 except that the first coating composition and the second coating composition described above were used.

### Example 5

### (1) Preparation of First Coating Composition

A coloring pigment dispersion A5 was prepared in the same manner as in Example 1 except that 39 parts of the white pigment (titanium dioxide), 1.9 parts of the black pigment (carbon black), 0.2 parts of the coloring pigment 3, 0.4 parts of the coloring pigment 4, and a luster pigment b (trade name: MH-8801, manufactured by Asahi Kasei Corporation, scaly aluminum pigment paste, active ingredient: 63.7%) were mixed such that the amount of the luster pigment b was 1.2 parts per 100 parts of the solid content of the first coating composition. A first coating composition was prepared in the same manner as in Example 1 except that the coloring pigment dispersion A5 was used instead of the coloring pigment dispersion A1.

### (2) Preparation of Second Coating Composition

### (2-1) Preparation of Coloring Pigment Dispersion B2

10 parts of the water-soluble acrylic resin solution of Production Example 2, 6 parts of the coloring pigment 2 (carbon black), 2.7 parts of the coloring pigment 3, 2.2 parts of the coloring pigment 4, 5 parts of the pigment dispersant (trade name: DISPEX ULTRA PA 4550AN), 69.4 parts of ion-exchanged water, and 1 part of the antifoaming agent (trade name: BYK-011) were mixed with a stirrer. Subsequently, the mixture was dispersed using a dispersing device packed with 0.05 mm zirconia beads in a volume packing ratio of 70%, affording a coloring pigment dispersion B2.

### (2-2) Preparation of Second Coating Composition

100 parts of the acrylic resin emulsion of Production Example 1, 1.4 parts of dimethylaminoethanol, 28.4 parts of the melamine resin (trade name: CYMEL 370N), 8.5 parts of the light interference pigment F, another luster pigment b (scaly aluminum pigment paste, trade name: MH-8801, manufactured by Asahi Kasei Corporation, active ingredient: 63.7%) in an amount of 0.2 parts per 100 parts of the solid content of the second coating composition, 1.6 parts of the coloring pigment dispersion B2, 5 parts of the phosphoric acid group-containing polymer of Production Example 2, 0.4 parts of lauryl acid phosphate, 50 parts of butyl cellosolve, 5.5 parts (3 parts in terms of solid content) of the surfactant (trade name: NOIGEN EA-207D), and 3 parts of linoleic acid (manufactured by Kishida Chemical Co., Ltd.) were uniformly dispersed. Dimethylaminoethanol was added to the dispersion such that the pH was adjusted to 8.1, and then the resulting mixture was diluted with deionized water to prepare an aqueous second coating composition having a total solid concentration of 25%.

A multilayer coating film and a coated article were obtained in the same manner as in Example 1 except that the first coating composition and the second coating composition described above were used.

### Comparative Example 1

### (1) Preparation of First Coating Composition

A coloring pigment dispersion a1 was prepared in the same manner as in Example 1 except that 7 parts of the white pigment (titanium dioxide) and the luster pigment b were mixed such that the amount of the luster pigment b was 9.5 parts per 100 parts of the solid content of the first coating composition. A first coating composition was prepared in the same manner as in Example 1 except that the coloring pigment dispersion a1 was used instead of the coloring pigment dispersion A1.

### (2) Preparation of Second Coating Composition

A second coating composition was prepared in the same manner as in Example 1 except that 5.1 parts of the light interference pigment F was blended instead of the light interference pigment A, and the blending amount of the light interference pigment C was changed to 6.8 parts.

A multilayer coating film and a coated article were obtained in the same manner as in Example 1 except that the first coating composition and the second coating composition described above were used.

### Comparative Example 2

### (1) Preparation of First Coating Composition

A coloring pigment dispersion a2 was prepared in the same manner as in Example 1 except that 33 parts of the white pigment (titanium dioxide), 0.9 parts of the black pigment (carbon black), 1 part of the coloring pigment 3, and 2.5 parts of the coloring pigment 4 were mixed. A first coating composition was prepared in the same manner as in Example 1 except that the coloring pigment dispersion a2 was used instead of the coloring pigment dispersion A1.

A multilayer coating film and a coated article were obtained in the same manner as in Comparative Example 1 except that the first coating composition described above was used.

### Comparative Example 3

### (1) Preparation of First Coating Composition

A coloring pigment dispersion a3 was prepared in the same manner as in Example 1 except that 49 parts of the white pigment (titanium dioxide) and 0.1 parts of the black pigment (carbon black) were mixed. A first coating composition was prepared in the same manner as in Example 1 except that the coloring pigment dispersion a3 was used instead of the coloring pigment dispersion A1.

A multilayer coating film and a coated article were obtained in the same manner as in Comparative Example 1 except that the first coating composition described above was used.

### Comparative Example 4

### (1) Preparation of First Coating Composition

A coloring pigment dispersion a4 was prepared in the same manner as in Example 1 except that 0.7 parts of the white pigment (titanium dioxide), 7 parts of the black pigment (carbon black), and 5.5 parts of the coloring pigment 4 were mixed. A first coating composition was prepared in the same manner as in Example 1 except that the coloring pigment dispersion a4 was used instead of the coloring pigment dispersion A1.

A multilayer coating film and a coated article were obtained in the same manner as in Comparative Example 1 except that the first coating composition described above was used.

### Comparative Example 5

### (1) Preparation of First Coating Composition

A coloring pigment dispersion a5 was prepared in the same manner as in Example 1 except that 49 parts of the white pigment (titanium dioxide) and 0.2 parts of the black pigment (carbon black) were mixed. A first coating composition was prepared in the same manner as in Example 1 except that the coloring pigment dispersion a5 was used instead of the coloring pigment dispersion A1.

### (2) Preparation of Second Coating Composition

A second coating composition was prepared in the same manner as in Example 1 except that 8.5 parts of a light interference pigment E (trade name: Xirallic T60-10, manufactured by MERCK) was used instead of the light interference pigments A and C.

A multilayer coating film and a coated article were obtained in the same manner as in Example 1 except that the first coating composition and the second coating composition described above were used.

### Comparative Example 6

### (2) Preparation of Second Coating Composition

### (2-1) Preparation of Coloring Pigment Dispersion B1

10 parts of the water-soluble acrylic resin solution of Production Example 2, 5.8 parts of the coloring pigment 2, 6.9 parts of the coloring pigment 4, 0.2 parts of a coloring pigment 5 (Dioxazine Violet, trade name: Hostaperm Violet RL, manufactured by Clariant), 7 parts of a pigment dispersing agent (trade name: DISPEX ULTRA PA 4550AN), 85 parts of ion-exchanged water, and 1.5 parts of the antifoaming agent (trade name: BYK-011) were mixed with a stirrer. Subsequently, the mixture was dispersed using a dispersing device packed with 0.05 mm zirconia beads in a volume packing ratio of 70%, affording a coloring pigment dispersion b1.

### (2-2) Preparation of Second Coating Composition

100 parts of the acrylic resin emulsion of Production Example 1, 1.4 parts of dimethylaminoethanol, 28.4 parts of the melamine resin (trade name: CYMEL 370N), 0.5 parts of the light interference pigment A, 1.2 parts of a light interference pigment D (trade name: Xirallic T60-22, manufactured by MERCK), 0.5 parts of the light interference pigment E, 0.7 parts of a light interference pigment G (trade name: VXC-SO, manufactured by Nihon Koken Kogyo Co., Ltd.), 60.7 parts of the coloring pigment dispersion b1, 5 parts of the phosphoric acid group-containing polymer of Production Example 2, 0.4 parts of lauryl acid phosphate, 50 parts of butyl cellosolve, 5.5 parts (3 parts in terms of solid content) of the surfactant (trade name: NOIGEN EA-207D), and 3 parts of linoleic acid (manufactured by Kishida Chemical Co., Ltd.) were uniformly dispersed. Dimethylaminoethanol was added to the dispersion such that the pH was adjusted to 8.1, and then the resulting mixture was diluted with deionized water to prepare an aqueous second coating composition having a total solid concentration of 15%.

A multilayer coating film and a coated article were obtained in the same manner as in Comparative Example 5 except that the second coating composition described above was used.

### Comparative Example 7

### (2) Preparation of Second Coating Composition

### (2-1) Preparation of Coloring Pigment Dispersion b2

10 parts of the water-soluble acrylic resin solution of Production Example 2, 29.4 parts of the coloring pigment 1, 0.7 parts of the coloring pigment 2, 1.9 parts of the coloring pigment 4, 2.3 parts of the coloring pigment 5, 3 parts of the pigment dispersant (trade name: DISPEX ULTRA PA 4550AN), 49.2 parts of ion-exchanged water, and 0.5 parts of the antifoaming agent (trade name: BYK-011) were mixed with a stirrer. Subsequently, the mixture was dispersed using a dispersing device packed with 0.05 mm zirconia beads in a volume packing ratio of 70%, affording a coloring pigment dispersion b2.

### (2-2) Preparation of Second Coating Composition

100 parts of the acrylic resin emulsion of Production Example 1, 1.4 parts of dimethylaminoethanol, 28.4 parts of the melamine resin (trade name: CYMEL 370N), 4.3 parts of the light interference pigment A, 4.3 parts of the light interference pigment F, 5.1 parts of another luster pigment b, 13.5 parts of the coloring pigment dispersion b2, 5 parts of the phosphoric acid group-containing polymer of Production Example 2, 0.4 parts of lauryl acid phosphate, 50 parts of butyl cellosolve, 5.5 parts (3 parts in terms of solid content) of the surfactant (trade name: NOIGEN EA-207D), and 3 parts of linoleic acid (manufactured by Kishida Chemical Co., Ltd.) were uniformly dispersed. Dimethylaminoethanol was added to the dispersion such that the pH was adjusted to 8.1, and then the resulting mixture was diluted with deionized water to prepare an aqueous second coating composition having a total solid concentration of 25%.

A multilayer (bilayer) coating film and a coated article were obtained in the same manner as in Example 1 except that the second coating composition described above was used and no first coating composition was used.

### Evaluation

Using the multilayer coating films obtained in the above examples and comparative examples, a single first coating film, or a single second coating film, the following evaluations were carried out. The results of the evaluations are shown in the following tables.

In the table, the mass (%) of the pigment contained in the second coating film is a ratio when the second coating film (the solid content of the second coating composition) is 100% by mass.

### (Preparation of Single First Coating Film)

The first coating composition described above was spray-applied onto an article to be coated obtained in the same manner as in Example 1 such that the dry coating film had a thickness of 15 μm, and the composition was heated and cured at 140° C. for 20 minutes. As a result, a cured coating film (a single first coating film) of the first coating composition applied to the article to be coated was obtained.

### (Preparation of Single Second Coating Film)

The second coating composition described above was spray-applied onto a polypropylene plate such that the dry film thickness was 15 μm, and then heated and cured at 140° C. for 20 minutes. Subsequently, the coating film was peeled off from the polypropylene plate, affording a film-like second coating film (a single second coating film).

### (Preparation of Test Coating Film)

An article to be coated was prepared, which was an approximately 174 mm×144 mm art paper having a white part and a black part with a solvent-resistant transparent coating material applied thereon, wherein the 45-degrees and 0-degrees diffusion reflectances were 80±1 in the white part and 2 or less in the black part.

The second coating composition described above was spray-applied onto the article to be coated such that the dry film thickness was 15 μm, and then heated and cured at 140° C. for 20 minutes. As a result, a cured coating film (a test coating film) of the second coating composition applied to the black article to be coated was obtained.

### (1) Lightness and Chroma

The lightness and chroma of the single first coating film, test coating film, or multilayer coating film were measured using a spectrophotometer (BYK-mac i manufactured by BYK Gardner GmbH).

### (2) Average Light Transmittance

The light transmittance of the single second coating film was measured in a section of 400 to 700 nm under conditions of a wavelength scan mode, a scan speed of 60 nm/min, and a sampling interval of 2 nm using a spectrophotometer (manufactured by Hitachi, Ltd., trade name: U-4100). The average light transmittance was obtained by averaging the light transmittance for every 10 nm.

### (3) Solid Feeling

The multilayer coating film was viewed from an angle corresponding to a light receiving angle of 45° (face region) and 110° C. (shade region), and evaluated on the basis of the following criteria. When no graininess is sensed, it can be evaluated that there is a solid feeling. In the case of rating A, it can be said that there is a desired design.

### Evaluation Criteria

A: Graininess due to the luster pigment is sparsely sensed in the face region, and almost no graininess is sensed in the shade region.
B: Graininess is sensed entirely in the face region, but the graininess is sensed merely sparsely in the shade region.
C: Graininess is sensed entirely in both the face and shade regions.

### (4) Gray Feeling

The chroma Cm*₄₅ and the lightness Lm*₄₅ of the multilayer coating film were evaluated on the basis of the following criteria. In the case of rating A, a gray feeling is sensed.

### Evaluation Criteria

A: Cm*₄₅≤10 and 30≤Lm*₄₅≤65 are satisfied.
B: 10<Cm*₄₅≤12 and 27≤Lm*₄₅≤68 are satisfied, or
Cm*₄₅≤12 and 27≤Lm*₄₅<30 are satisfied, or
Cm*₄₅≤12 and 65<Lm*₄₅≤68 are satisfied.
C: Cm*₄₅>12, or Lm*₄₅<27, or Lm*₄₅>68 is satisfied.

### (5) Tint

The chroma Cm*₁₅ of the multilayer coating film was evaluated on the basis of the following criteria. In the case of rating A, a tint is sensed.

### Evaluation Criteria

A: Cm*₁₅>10 is satisfied.
B: 7<Cm*₁₅≤10 is satisfied.
C: Cm*₁₅≤7.

TABLE 1

| | | Trade name | Manufacturer | Hue | Substrate |
|---|---|---|---|---|---|
| Pigment | Light interference pigment A | Xirallic T60-23 | Merck | Blue | Alumina flake |
| contained | Light interference pigment B | Xirallic T60-20 | Merck | Yellow | Alumina flake |
| in second | Light interference pigment C | Xirallic T60-25 | Merck | Turquoise | Alumina flake |
| coating | Light interference pigment D | Xirallic T60-22 | Merck | Violet | Alumina flake |
| film | Light interference pigment E | Xirallic T60-10 | | Silver | Alumina flake |
| (%) | Light interference pigment F | BXC- [symbol] | Nihon Koken | Blue | Mica |
| | Light interference pigment G | VXC- [symbol] | Nihon Koken | Violet | Mica |
| | Other luster pigment a | GT1020R [symbol] | Nippon Sheet Glass | Achromatic | Glass flake |
| | Other luster pigment b | MH- [symbol] 01 | A [symbol] i Ka [symbol] i | Achromatic | Alumi [symbol] |
| | Coloring pigment 1 | Titanium | | White | |
| | Coloring pigment 2 | Carbon black | | Black | |
| | Coloring pigment 3 | Quinacridone Red | | Red | |
| | Coloring pigment 4 | Cyanine Blue | | Blue | |
| | Coloring pigment 5 | Dioxazine Violet | | Purple | |
| First coating | Chrome C [symbol] *45 | | | | |
| film | Lightness L [symbol] *45 | | | | |
| | L [symbol] * [symbol] 5-L [symbol] * [symbol] 0 | | | | |
| Second coating | Average light transmittance (%) | | | | |
| film | Chrom [symbol] C2* [symbol] 5 | | | | |
| Multilayer | C [symbol] *15 | | | | |
| coating | C [symbol] *45 | | | | |
| film | C [symbol] *15-C [symbol] *45 | | | | |
| | Lm*45 | | | | |
| | Solid feeling | | | | |
| | Gray feeling | | | | |
| | [symbol] | | | | |

| | Example | | | | | Comparative Example | | | | | | |
|---|---|---|---|---|---|---|---|---|---|---|---|---|
| | 1 | 2 | 3 | 4 | 5 | 1 | 2 | 3 | 4 | 5 | 6 | 7 |
| Pigment | 1.0 | | | 1.0 | | | | | | | 0.3 | 2.5 |
| contained | | | 5.0 | | | | | | | | | |
| in second | 1.0 | 6.0 | | | | 4.0 | 4.0 | 4.0 | 4.0 | | | |
| coating | | | | | | | | | | | 0.7 | |
| film | | | | | | | | | | 5.0 | 0.3 | |
| (%) | | 5.0 | | | 5.0 | 3.0 | 3.0 | 3.0 | 3.0 | | | 2.5 |
| | | | | | | | | | | | 0.4 | |
| | | | 5.0 | | | | | | | | | |
| | | | | | 0.2 | | | | | | | 3.0 |
| | | | | 0.5 | | | | | | | | 0.8 |
| | | | | 0.100 | 0.050 | | | | | | 0.400 | 0.800 |
| | | | | 0.010 | 0.030 | | | | | | | |
| | | | | 0.001 | 0.020 | | | | | | 0.600 | 0.200 |
| | | | | | | | | | | | 0.020 | 0.200 |
| First coating | 3.16 | 1.62 | 3.1 [symbol] | 9.53 | 4.1 [symbol] | 1.16 | 18.60 | 2.50 | 12.40 | 1.62 | 1.62 | — |
| film | 4 [symbol] .00 | 61.60 | 43.00 | 40.80 | 44. [symbol] 0 | 67.20 | 33.80 | 75.90 | 5.10 | 61. [symbol] 0 | 61. [symbol] 0 | — |
| | 2.70 | [symbol] .61 | 2.70 | 0.81 | 10. [symbol] 8 | 35.30 | 2.10 | 2.80 | 11.00 | 3.61 | 3.61 | — |
| Second coating | 87 | 75 | 77 | 72 | 65 | 80 | [symbol] 0 | 80 | [symbol] 0 | 85 | [symbol] | 1.5 |
| film | 9.50 | 2 [symbol] .90 | 29.50 | 7.10 | 11.00 | 21.00 | 21.00 | 21.00 | 21.00 | 4. [symbol] | 16. [symbol] 0 | — |
| Multilayer | 19.50 | 31.20 | 32.50 | 15.40 | 13.30 | 4.80 | 21.60 | 10.00 | 22.00 | 3.90 | 17.50 | 2.00 |
| coating | 1.20 | 1.30 | 2. [symbol] 0 | 8. [symbol] 0 | 2.90 | 3.30 | 13.18 | 2.50 | 10.30 | 2. [symbol] | 5. [symbol] | 0. [symbol] |
| film | 18.30 | 2 [symbol] .90 | 29.70 | 6. [symbol] 0 | 10.40 | 1.50 | 8.42 | 7. [symbol] 0 | 1 [symbol] .70 | 1.65 | 11.9 [symbol] | 1.40 |
| | 43.30 | 60.70 | 59.2 [symbol] | 3 [symbol] .80 | [symbol] 1.90 | 62.40 | 35.90 | [symbol] 8.90 | 24. [symbol] | 52. [symbol] 0 | 4.40 | 42.90 |
| | A | A | A | A | A | C | A | A | A | A | C | C |
| | A | A | A | A | A | A | C | C | C | A | C | A |
| | A | A | A | A | A | C | A | B | A | C | A | C |

[symbol]

indicates data missing or illegible when filed

All the multilayer coating films of Examples were coating films having a unique design that was visually recognized as a gray solid coating film in a face region while a chromatic tint was sensed in a highlight region.

Comparative Example 1 is an example of a metallic coating film having a high flip-flop value of the first coating film. The multilayer coating film of Comparative Example 1 exhibited no chromatic tint in the highlight region, and exhibited no solid feeling as well.

Comparative Example 2 is an example in which the first coating film had a high chroma. The multilayer coating film of Comparative Example 2 had no gray feeling, and did not have the design intended by the present disclosure.

Comparative Examples 3 and 4 are examples in which the lightness of the first coating film is out of the range of the present disclosure. These multilayer coating films did not have a gray feeling and did not have the design intended by the present disclosure.

Comparative Example 5 is an example in which the chroma of a multilayer coating film is out of the range of the present disclosure. The multilayer coating film of Comparative Example 5 exhibited no chromatic tint in the highlight region.

Comparative Example 6 is an example in which the second coating film had a low average light transmittance. In the multilayer coating film of Comparative Example 6, since the second coating film had low transparency, the gray feeling of the first coating film could not be recognized and a solid feeling was not obtained.

Comparative Example 7 is an example in which pigments for adjusting lightness (white pigment and black pigment) and a scaly pigment are contained in one coating film. In the coating film of Comparative Example 7, a solid feeling was not sensed in the face region.

The present disclosure includes the following embodiments.

[1]

A multilayer coating film including a first coating film, a second coating film disposed on the first coating film, and a clear coating film disposed on the second coating film,
in which
the second coating film contains a scaly pigment coated with a metal oxide,
a chroma C1*₄₅ and a lightness L1*₄₅ in an L*C*h color system based on a spectral reflectance of reflected light R1₄₅ having received, at an angle of 45 degrees with respect to specular light, incident light I1₄₅ striking at an angle of 45 degrees with respect to a surface of the first coating film satisfy relationships of:

$$C {1}_{45}^{*} \leq 15 \\ 20 \leq L {1}_{45}^{*} \leq 70 ,$$

a lightness L1*₁₅ in the L*C*h color system based on a spectral reflectance of reflected light R1₁₅ having received the incident light I1₄₅ at an angle of 15 degrees with respect to the specular light, and a lightness L1*₁₁₀ in the L*C*h color system based on a spectral reflectance of reflected light R₁₁₀ having received the incident light I1₄₅ at an angle of 110 degrees with respect to the specular light satisfy a relationship of:

$$L {1}_{15}^{*} - L {1}_{110}^{*} \leq 15 ,$$

the second coating film has an average light transmittance at a wavelength of 400 nm to 700 nm of 50% or more, and
a chroma Cm*₁₅ in the L*C*h color system based on a spectral reflectance of reflected light Rm₁₅ having received, at an angle of 15 degrees with respect to specular light, incident light Im₄₅ striking at an angle of 45 degrees with respect to a surface of the multilayer coating film, and a chroma Cm*₄₅ in the L*C*h color system based on a spectral reflectance of reflected light Rm₄₅ having received the incident light Im₄₅ at an angle of 45 degrees with respect to the specular light satisfy relationships of:

$${Cm}_{15}^{*} > 10 \\ {Cm}_{15}^{*} - {Cm}_{45}^{*} > 5.$$

[2]

The multilayer coating film according to [1], in which a chroma C2*₁₅ in the L*C*h color system based on a spectral reflectance of reflected light R2₁₅ having received, at an angle of 15 degrees with respect to specular light, incident light I2₄₅ striking at an angle of 45 degrees with respect to a surface of a test coating film obtained by applying, onto a black article to be coated, a second coating composition to be used for formation of the second coating film satisfies a relationship of:

$$C {2}_{15}^{*} \geq 5.$$

[3]

The multilayer coating film according to [1] or [2], in which a content of the scaly pigment is 0.5% to 20% by mass of the second coating film.

[4]

The multilayer coating film according to any one of [1] to [3], in which
the second coating film further contains a coloring pigment, and
a content of the coloring pigment is 0.05% to 1.5% by mass of the second coating film.
   [5]

The multilayer coating film according to [4], in which a mass ratio of the scaly pigment to the coloring pigment is 2 to 400.

[6]

A coated article including:
an article to be coated; and
the multilayer coating film according to any one of [1] to [5] disposed on the article to be coated.
   [7]

A method for producing a coated article having a multilayer coating film, the method including:
applying a first coating composition onto an article to be coated to form a first coating film;
applying a second coating composition containing a scaly pigment coated with a metal oxide onto the first coating film to form a second coating film; and
applying a clear coating composition onto the second coating film to form a clear coating film,
in which
a chroma C1*₄₅ and a lightness L1*₄₅ in an L*C*h color system based on a spectral reflectance of reflected light R1₄₅ having received, at an angle of 45 degrees with respect to specular light, incident light I1₄₅ striking at an angle of 45 degrees with respect to a surface of the first coating film satisfy relationships of:

$$C {1}_{45}^{*} \leq 15 \\ 20 \leq L {1}_{45}^{*} \leq 70 ,$$

a lightness L1*₁₅ in the L*C*h color system based on a spectral reflectance of reflected light R1₁₅ having received the incident light I1₄₅ at an angle of 15 degrees with respect to the specular light, and a lightness L1*₁₁₀ in the L*C*h color system based on a spectral reflectance of reflected light R₁₁₀ having received the incident light I1₄₅ at an angle of 110 degrees with respect to the specular light satisfy a relationship of:

$$L {1}_{15}^{*} - L {1}_{110}^{*} \leq 15 ,$$

the second coating film has an average light transmittance at a wavelength of 400 nm to 700 nm of 50% or more, and
a chroma Cm*₁₅ in the L*C*h color system based on a spectral reflectance of reflected light Rm₁₅ having received, at an angle of 15 degrees with respect to specular light, incident light Im₄₅ striking at an angle of 45 degrees with respect to a surface of the multilayer coating film, and a chroma Cm*₄₅ in the L*C*h color system based on a spectral reflectance of reflected light Rm₄₅ having received the incident light Im₄₅ at an angle of 45 degrees with respect to the specular light satisfy relationships of:

$${Cm}_{15}^{*} > 10 \\ {Cm}_{15}^{*} - {Cm}_{45}^{*} > 5.$$

The multilayer coating film of the present disclosure exhibits a calm gray color in the face region and a chromatic tint is sensed in the highlight region, so that a new design can be imparted to various articles to be coated.

What is claimed is:

1. A multilayer coating film comprising a first coating film, a second coating film disposed on the first coating film, and a clear coating film disposed on the second coating film,
wherein
the second coating film contains a scaly pigment coated with a metal oxide,
a chroma C1*₄₅ and a lightness L1*₄₅ in an L*C*h color system based on a spectral reflectance of reflected light R1₄₅ having received, at an angle of 45 degrees with respect to specular light, incident light I1₄₅ striking at an angle of 45 degrees with respect to a surface of the first coating film satisfy relationships of:
$$C {1}_{45}^{*} \leq 15 \\ 20 \leq L {1}_{45}^{*} \leq 70 ,$$
a lightness L1*₁₅ in the L*C*h color system based on a spectral reflectance of reflected light R1₁₅ having received the incident light I1₄₅ at an angle of 15 degrees with respect to the specular light, and a lightness L1*₁₁₀ in the L*C*h color system based on a spectral reflectance of reflected light R1₁₁₀ having received the incident light I1₄₅ at an angle of 110 degrees with respect to the specular light satisfy a relationship of:
$$L {1}_{15}^{*} - L {1}_{110}^{*} \leq 15 ,$$
the second coating film has an average light transmittance at a wavelength of 400 nm to 700 nm of 50% or more, and
a chroma Cm*₁₅ in the L*C*h color system based on a spectral reflectance of reflected light Rm₁₅ having received, at an angle of 15 degrees with respect to specular light, incident light Im₄₅ striking at an angle of 45 degrees with respect to a surface of the multilayer coating film, and a chroma Cm*₄₅ in the L*C*h color system based on a spectral reflectance of reflected light Rm₄₅ having received the incident light Im₄₅ at an angle of 45 degrees with respect to the specular light satisfy relationships of:
$${Cm}_{15}^{*} > 10 \\ {Cm}_{15}^{*} - {Cm}_{45}^{*} > 5.$$

2. The multilayer coating film according to claim 1, wherein a chroma C2*₁₅ in the L*C*h color system based on a spectral reflectance of reflected light R2₁₅ having received, at an angle of 15 degrees with respect to specular light, incident light I2₄₅ striking at an angle of 45 degrees with respect to a surface of a test coating film obtained by applying, onto a black article to be coated, a second coating composition to be used for formation of the second coating film satisfies a relationship of:
$$C {2}_{15}^{*} \geq 5.$$

3. The multilayer coating film according to claim 1, wherein a content of the scaly pigment is 0.5% to 20% by mass of the second coating film.

4. The multilayer coating film according to claim 1, wherein
the second coating film further contains a coloring pigment, and
a content of the coloring pigment is 0.05% to 1.5% by mass of the second coating film.

5. The multilayer coating film according to claim 4, wherein a mass ratio of the scaly pigment to the coloring pigment is 2 to 400.

6. A coated article comprising:
an article to be coated; and
the multilayer coating film according to claim 1 disposed on the article to be coated.

7. A method for producing a coated article having a multilayer coating film including a first coating film, a second coating film disposed on the first coating film, and a clear coating film disposed on the second coating film, the method comprising:
applying a first coating composition onto an article to be coated to form the first coating film;
applying a second coating composition containing a scaly pigment coated with a metal oxide onto the first coating film to form the second coating film; and
applying a clear coating composition onto the second coating film to form the clear coating film,
wherein
a chroma C1*₄₅ and a lightness L1*₄₅ in an L*C*h color system based on a spectral reflectance of reflected light R1₄₅ having received, at an angle of 45 degrees with respect to specular light, incident light I1₄₅ striking at an angle of 45 degrees with respect to a surface of the first coating film satisfy relationships of:
$$C {1}_{45}^{*} \leq 15 \\ 20 \leq L {1}_{45}^{*} \leq 70 ,$$
a lightness L1*₁₅ in the L*C*h color system based on a spectral reflectance of reflected light R1₁₅ having received the incident light I1₄₅ at an angle of 15 degrees with respect to the specular light, and a lightness L1*₁₁₀ in the L*C*h color system based on a spectral reflectance of reflected light R1₁₁₀ having received the incident light I1₄₅ at an angle of 110 degrees with respect to the specular light satisfy a relationship of:
$$L {1}_{15}^{*} - L {1}_{110}^{*} \leq 15 ,$$
the second coating film has an average light transmittance at a wavelength of 400 nm to 700 nm of 50% or more, and
a chroma Cm*₁₅ in the L*C*h color system based on a spectral reflectance of reflected light Rm₁₅ having received, at an angle of 15 degrees with respect to specular light, incident light Im₄₅ striking at an angle of 45 degrees with respect to a surface of the multilayer coating film, and a chroma Cm*₄₅ in the L*C*h color system based on a spectral reflectance of reflected light Rm₄₅ having received the incident light Im₄₅ at an angle of 45 degrees with respect to the specular light satisfy relationships of:
$${Cm}_{15}^{*} > 10 \\ {Cm}_{15}^{*} - {Cm}_{45}^{*} > 5.$$
